(19) United States
(12) Patent Application Publication
(10) Pub. No.: US 2013/0290266 A1
(43) Pub. Date: Oct. 31, 2013

(54) DOCUMENT-TYPE AND CAPTURE METHOD AGNOSTIC VERSIONING OF AN ARCHIVED DOCUMENT

(71) Applicant: Rahul Kapoor, Bellevue, WA (US)

(72) Inventor: Rahul Kapoor, Bellevue, WA (US)

(21) Appl. No.: 13/457,112

(22) Filed: Apr. 26, 2012

(51) Int. Cl. G06F 17/30

(52) U.S. Cl. 707/661; 707/E17.008

(57) ABSTRACT

Versioning of an archived document having at least one of a first element, a second element, and a third element, is managed. The first element is mapped to a source set identifier, the second element is mapped to a first source identifier, and/or the third element is mapped to a second source identifier. The source set identifier, the first source identifier, and the second source identifier are agnostic to a type of the document and a method in which the document is captured. A determination is made as to whether the document comprises a copy of an existing document in an archive, a new version of an existing document in the archive, or a new document to be stored in the archive based upon an analysis of the mapped at least one of the source set identifier, the first source identifier, and the second source identifier.

### BACKGROUND

Electronic documents are commonly archived for various reasons, including ease of accessibility and/or compliance with legal requirements. In addition, versioning schemes that enable the electronic documents to be stored in several versions at the same time are typically implemented in archiving the electronic documents.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a document management apparatus, according to an example of the present disclosure;

FIG. 2 shows a flow diagram of a method for managing versioning of an archived document, according to an example of the present disclosure;

FIGS. 3A and 3B, collectively show a flow diagram of a method for managing versioning of an archived document, according to an example of the present disclosure;

FIG. 4 illustrates a table that depicts various source set identifiers, first source identifiers, and second source identifiers corresponding to various types of documents, according to an example of the present disclosure; and

FIG. 5 illustrates a schematic representation of a computing device, which may be employed to perform various functions of the document management apparatus depicted in FIG. 1, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

As used throughout the present disclosure, the term “document” is intended to encompass an electronic document, such as an electronic mail (e-mail), a word processing document, a spreadsheet document, a webpage, a computer aided drawing document, etc. The term “document” may also encompass an electronic file folder containing any of the documents previously discussed. As also used herein, the term “includes” means includes but not limited to, the term “including” means including but not limited to. The term “based on” means based at least in part on. In addition, the terms “a” and “an” are intended to denote at least one of a particular element.

Disclosed herein is a method for managing versioning of an archived document having at least one of a first element, a second element, and a third element. Also disclosed herein are an apparatus for implementing the method and a non-transitory computer readable medium on which is stored machine readable instructions that implement the method.

As discussed in greater detail herein below, the first element is mapped to a source set identifier, the second element is mapped to a first source identifier, and/or the third element is mapped to a second source identifier, in which the source set identifier, the first source identifier, and the second source identifier are agnostic to a type of the document and a method in which the document is captured. In addition, a determination is made as to whether the document comprises a copy of an existing document in the archive, a new version of an existing document in the archive, or a new document to be stored in the archive based upon an analysis of the mapped at least one of the source set identifier, the first source identifier, and the second source identifier.

Through implementation of various examples of the present disclosure, management of the versioning of archived documents may be implemented in a document type and capture method agnostic manner. In other words, the same method may be implemented to manage the versioning of different types of archived documents, without requiring that the method be changed to accommodate the different types of documents. As such, various examples of the present disclosure provide archiving and versioning schemes that may be implemented on a relatively wide range of document types through a unified platform.

In addition, according to an example of the present disclosure, the documents are archived in document sets, which are identified by the respective source set identifiers. More particularly, for instance, each version of the same document may be located using the same source set identifier. In one regard, by identifying the documents through use of the source set identifiers, all of the changes to a particular document may be logically tied to the same document set. According to an example in which the document comprises an e-mail, a forwarded e-mail that contains no content changes may be inserted as a new version in the same document set as the original e-mail, however, an e-mail that contains content changes, may be determined to be a new e-mail, and may thus be inserted into a new document set.

According to an example, if the source of the document has a definition of a document set, that definition may be used as the source set identifier of that document set. Otherwise, a new source set identifier for the document set may be created.

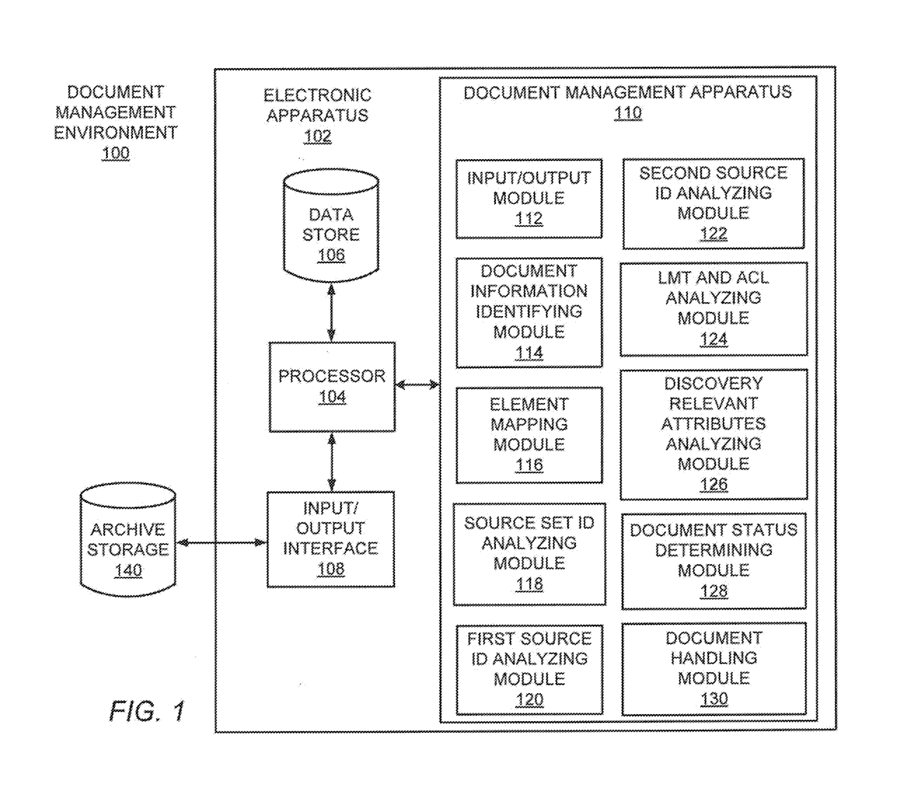

With reference first to FIG. 1, there is shown a block diagram of a document management environment 100, according to an example of the present disclosure. It should be understood that the document management environment 100 may include additional components and that one or more of the components described herein may be removed and/or modified without departing from a scope of the document management environment 100.

The document management environment 100 is depicted as including an electronic apparatus 102 and an archive storage 140. The electronic apparatus 102 is further depicted as including a processor 104, a data store 106, an input/output interface 108, and a document management apparatus 110. The electronic apparatus 102 comprises a server, a computer, a laptop computer, a tablet computer, a personal digital assistant, a cellular telephone, or other electronic apparatus that is to perform a method for managing archiving of a document disclosed herein. In addition, the archive storage 140 comprises a location in which documents are to be archived by the document management apparatus, and comprises a data storage of the electronic apparatus 102 or a data storage that is separate from the electronic apparatus 102. According to an example, the electronic apparatus 102 is connected to the archive storage 140 through a local connection, or through a network.

The document management apparatus 110 is depicted as including an input/output module 112, a document information identifying module 114, an element mapping module 116, a source set identifier (ID) analyzing module 118, a first source ID analyzing module 120, a second source ID analyzing module 122, a last modification time (LMT) and access control list (ACL) analyzing module 124, a discovery relevant attributes analyzing module 126, a document status determining module 128, and a document handling module 130. The processor 104, which may comprise a microprocessor, a micro-controller, an application specific integrated circuit (ASIC), and the like, is to perform various processing functions in the electronic apparatus 102. One of the processing functions includes invoking or implementing the modules 112-130 contained in the document management apparatus 110 as discussed in greater detail herein below.

According to an example, the document management apparatus 110 comprises a hardware device, such as a circuit or multiple circuits arranged on a board. In this example, the modules 112-130 comprise circuit components or individual circuits. According to another example, the document management apparatus 110 comprises a volatile or non-volatile memory, such as dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like. In this example, the modules 112-130 comprise software modules stored in the document management apparatus 110. According to a further example, the modules 112-130 comprise a combination of hardware and software modules.

The input/output interface 108 may comprise a hardware and/or a software interface. In any regard, the input/output interface 108 may be connected to a network, such as the Internet, an intranet, etc., over which the document management apparatus may receive and communicate data, for instance, documents to be archived. The processor 104 may store data received through the input/output interface 108 in the data store 106 and may use the data in implementing the modules 112-130. The data store 106 comprises volatile and/or non-volatile memory, such as DRAM, EEPROM, MRAM, phase change RAM (PCRAM), Memristor, flash memory, and the like. In addition, or alternatively, the data store 106 comprises a device that is to read from and write to a removable media, such as a floppy disk, a CD-ROM, a DVD-ROM, or other optical or magnetic media.

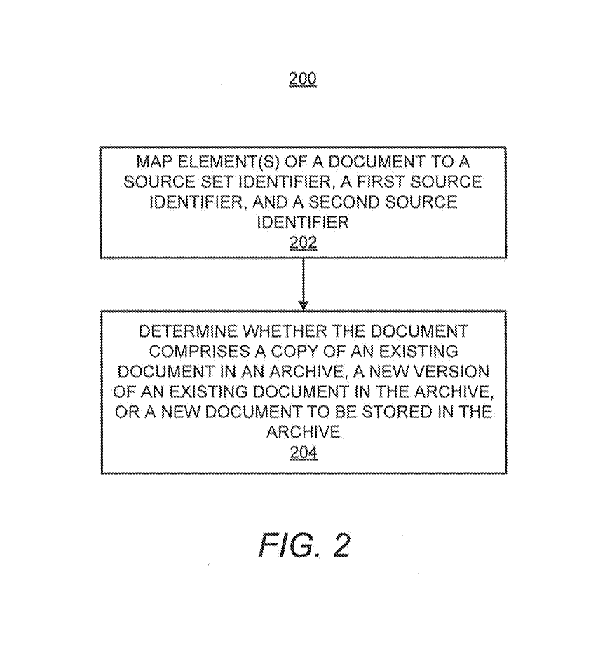

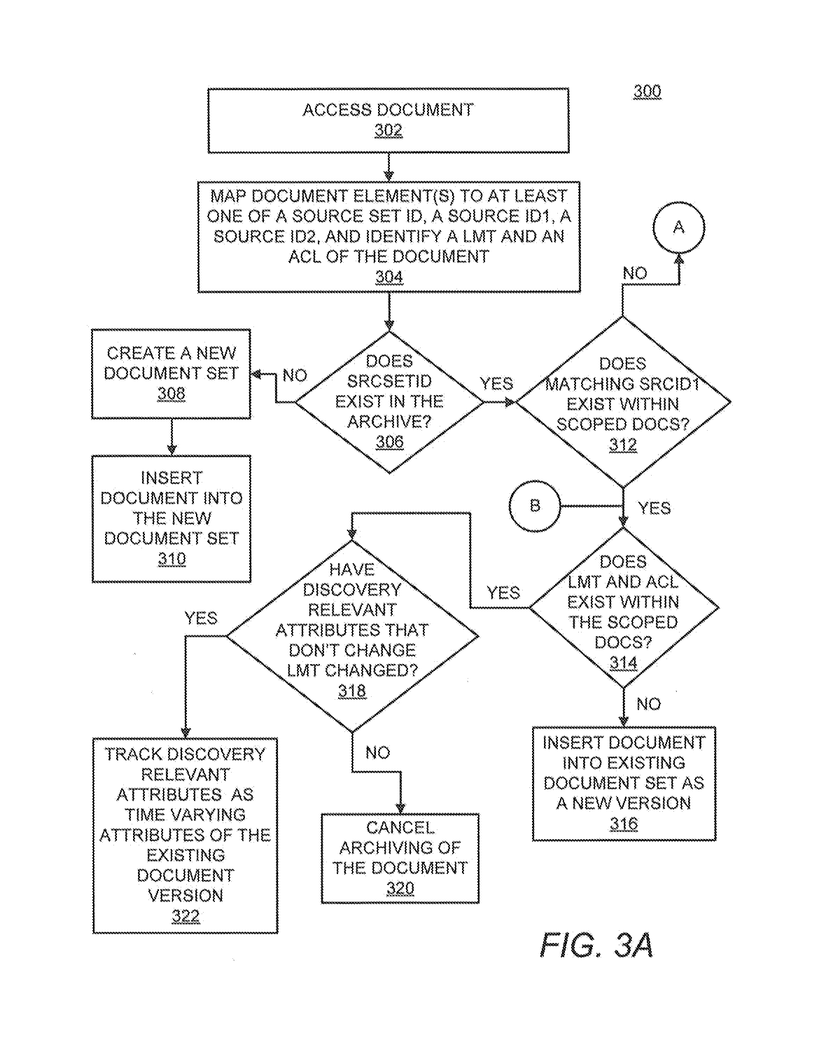

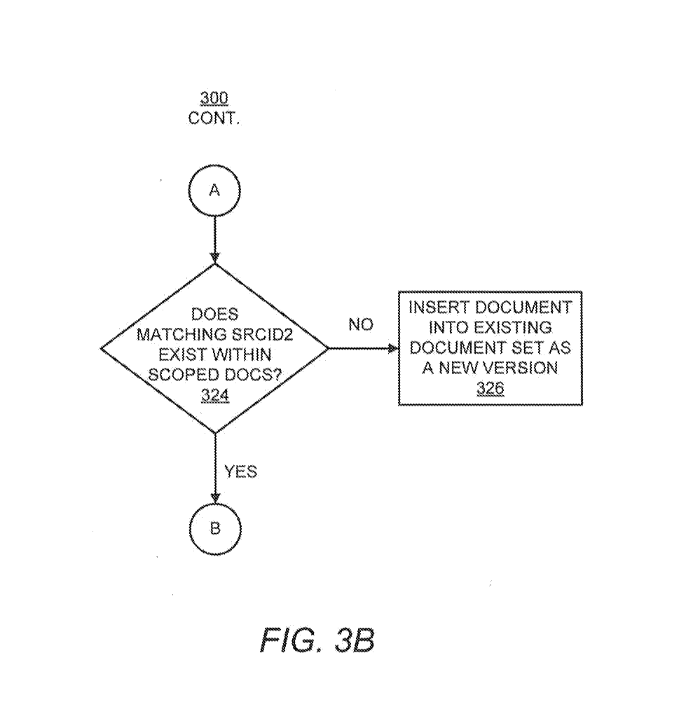

Various manners in which the modules 112-130 of the document management apparatus 110 may be implemented are discussed in greater detail with respect to the methods 200 and 300 depicted in FIGS. 2 and 3A-3B. FIGS. 2 and 3A-3B, respectively depict flow diagrams of methods 200, 300 for managing versioning of an archived document, according to examples of the present disclosure. It should be apparent to those of ordinary skill in the art that the methods 200 and 300 represents generalized illustrations and that other operations may be added or existing operations may be removed, modified, or rearranged without departing from the scopes of the methods 200 and 300. Although particular reference is made to the document management apparatus 110 depicted in FIG. 1 as comprising an apparatus and/or a set of machine readable instructions that may perform the operations described in the methods 200 and 300, it should be understood that differently configured apparatuses and/or machine readable instructions may perform the methods 200 and 300 without departing from the scopes of the methods 200 and 300.

Generally speaking, the methods 200 and 300 may separately be implemented to manage archiving and versioning of a document, in which the document comprises any of a plurality of different types of documents. In addition, the methods 200 and 300 may be implemented to manage archiving of a document, in which the document is captured through any of a plurality of different manners of capturing the document. In other words, the methods 200 and 300 may be implemented to manage the versioning of archived documents regardless of the document types, without requiring that the methods 200 and 300 be substantially modified. As such, the methods 200 and 300 may be implemented to manage the versioning of the documents in an archive, in a document type and capture method agnostic manner. The method 300 is related to the method 200 in that the method 300 includes additional descriptions of the operations in the method 200.

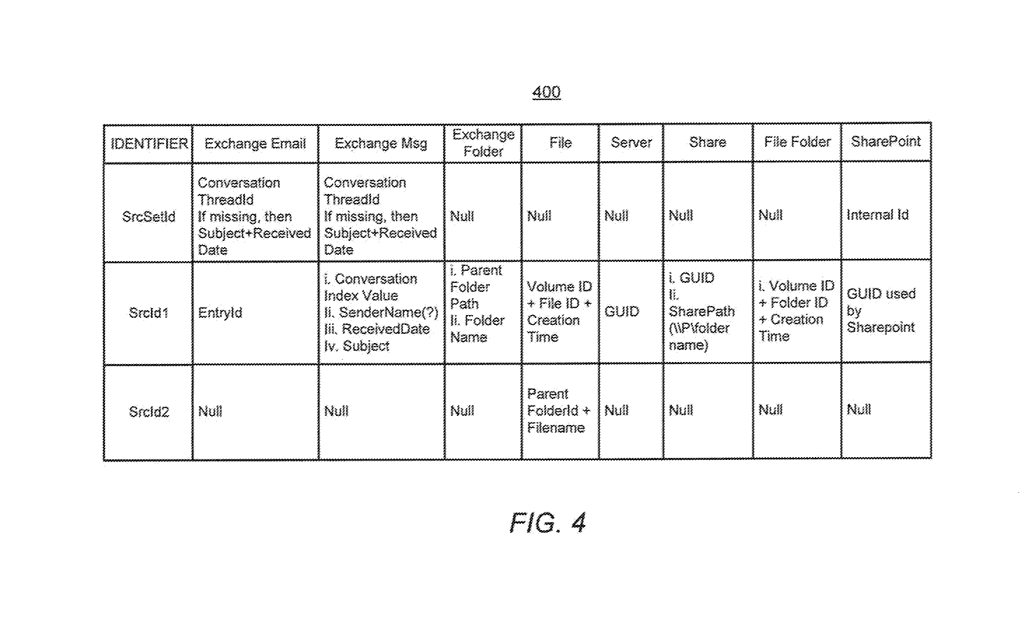

With reference first to FIG. 2, at block 202, a first element of a document is mapped to a source set identifier, a second element of the document is mapped to a first source identifier, and/or a third element of the document is mapped to a second source identifier, for instance, by the element mapping module 116. The first, second, and third elements of the document may vary depending on the type of the document and may be defined differently for different types of documents. Thus, the first element of a particular type of document may differ from the first element of another type of document. In addition, certain types of documents may include the first element and the second element, but may not include the third element. As another example, other types of documents may include the second and third elements, but may not include the first element. As a further example, other types of documents include the second element, but may not include either of the first or third elements. Other combinations of elements are also possible. In addition, examples of various types of documents and their corresponding first, second, and/or third elements are provided in FIG. 4, which is described in greater detail below.

In the event that the document includes less than each of the first, second, and third elements, the mapping of the elements at block 202 may include setting the respective identifiers of the missing elements as having null values.

According to an example, the document may initially be parsed prior to implementation of the method 200 (and method 300) to identify the first, second, and third elements, if applicable. The parsing of the document may be performed by the document management apparatus 110 or by another apparatus or set of machine-readable instructions (not shown). In any regard, parsing of the document may include a determination of the source from which the document was either received or created, for instance, to determine the type of the document. In addition, the parsing of the document may also include a determination of the first, second, and/or third elements based upon the determined type of the document, which are mapped to the source set identifier, the first source identifier, and/or the second source identifier at block 202.

The parsing of the document may further include splitting of the document into multiple components, for instance, for storage efficiency. By way of example in which the document comprises an e-mail, the parsing of the e-mail may include splitting the e-mail into a body component, an attachment component, and a header information component. Alternatively, the splitting of the document may occur following performance of the method 200 or 300.

According to an example, identifications as to which characteristics of various types of documents correspond to the first, second, and/or third elements may have previously been determined and stored. Thus, for instance, a table or other suitably formatted arrangement, may include information correlating which characteristics of the document are to be construed as comprising the first, second, and/or third elements of the various types of documents. By way of particular example, for MS Exchange™ e-mail documents, the first element may be identified as corresponding to a conversation thread ID or the subject and the date that the e-mail was received.

At block 204, a determination is made as to whether the document comprises a copy of an existing document in the archive, a new version of an existing document in the archive, or a new document to be stored in the archive based upon an analysis of the mapped at least one of the source set identifier, the first source identifier, and the second source identifier, for instance, by the document status determining module 128. In addition, the document may be handled according to the determined status, for instance, by the document handling module 130.

Turning now to FIG. 3A, at block 302, a document to be archived is accessed, for instance, by the input/output module 112. The document to be archived, which is also referred to herein as simply the “document”, may be accessed in any of a variety of different manners. According to an example, the document is stored in the data store 106 of the electronic apparatus 102 and the document management apparatus 110 accesses the document from the data store 106. In another example, the document is stored in a separate electronic apparatus, for instance, on a client device that is in communication with the electronic apparatus 102 through the input/output interface 108. In any regard, a user may manually initiate the archiving of the document or the document may be accessed automatically by the document management apparatus 110 as part of a scheduled or routine archiving operation.

At block 304, a first element of the document is mapped to a source set identifier, a second element of the document is mapped to a first source identifier, and/or a third element of the document is mapped to a second source identifier, for instance, by the element mapping module 116. Various manners in which the operations performed at. block 304 are described in greater detail herein above with respect to block 202 in FIG. 2. In addition, at block 304, a last modification time (LMT) and an access control list (ACL) of the document are identified, for instance, by the document information identifying module 114. The last modification time and the access control list attributes of the document may be identified through, for instance, parsing of header information of the document for these attributes.

At block 306, a determination is made as to whether the source set identifier (SrcSetID) exists in the archive, for instance, by the source set identifier analyzing module 118. More particularly, a search is performed in the archive and/or an indication, such as a table, of the documents contained in the archive for the source set identifier of the document determined at block 304 to determine whether the source set identifier of the document exists in the archive. According to an example, the source set identifier of the document is hashed through implementation of any suitable hashing technique, and the hashed version of the source set identifier is used to search the archive and/or indication of the documents contained in the archive.

In response to a determination that the source set identifier of the document does not exist in the archive, at block 308, a new document set identified by the source set identifier is created, for instance, by the document handling module 130. In addition, at block 310, the document is inserted (e.g., archived) into the new document set, for instance, by the document handling module 130. In one regard, the document is inserted into the new document set to enable the document to be identified through the source set identifier. In addition, as discussed in greater detail herein below, additional versions of the document may be inserted into the new document set identified by the source set identifier, such that the additional versions of the document may also be identified through the source set identifier. The document set identified by a particular source set identifier therefore captures all of the changes that are made to the same document.

In response to a determination that the source set identifier does exist in the archive, at block 312, a determination is made as to whether the first source identifier (SrcID1) of the document determined at block 304 matches an archived first source identifier within a set of documents in the archive matching the source set identifier, for instance, by the first source identifier analyzing module 120. According to an example, a hash of the first source identifier is used to search the archive and/or indication of the documents contained in the archive for the match. In certain instances, and as discussed above, the document may not include a first element, and therefore the source set identifier of the document may have been set to a null value. In these instances, the determination at block 312 may instead be made in response to the source set identifier having a null value. In any regard, the “yes” condition at block 306 may be construed as indicating that the document belongs within an existing document set stored in the archive. Alternatively, the “yes” condition at block 306 may be construed as indicating that the document is not associated with the source set identifier in the archive, but that a copy of the document or another version of the document may still be stored in the archive. In this regard, at block 312, a determination may instead be made as to whether the first source identifier of the document matches an archived first source identifier.

In response to a determination that a first source identifier that matches the first source identifier of the document exists, for instance, that the matching first source identifier exists within a set of documents in the archive matching the source set identifier, at block 314, a determination is made as to whether the last modification time and the access control list of the document identified at block 304 exist within the set of documents in the archive matching the source set identifier, for instance by the LMT and ACL analyzing module 124. In response to a determination that the last modification time and the access control list of the document identified at block 304 does not exist within the archive, for instance, within the set of documents in the archive matching the source set identifier, at block 316, the document is inserted into the archive, for instance, into the document set matching the source set identifier, as a new version of an existing document.

However, at block 314, in response to a determination that the last modification time and the access control list of the document identified at block 304 does exist within the archive, for instance, within the set of documents in the archive matching the source set identifier, a determination is made as to whether discovery relevant attributes that do not change the last modified time identified at block 304 has changed, for instance, by the discovery relevant attributes analyzing module 126. Examples of discovery relevant attributes that do not change the last modified time of a message include whether the message is Read/Unread and the Category in which the message is placed. Because these types of message attributes are performed by message reading clients, for instance, Microsoft Outlook™, Mozilla Thunderbird™, etc., they may not change the last modified time. When messages are restored from an archive, attributes such as “Categorization” and “Read/Unread” are to be preserved so that they are “discovery relevant”.

In response to a determination that the discovery relevant attributes that do not change the last modified time identified at block 304 have not changed, at block 320, archiving of the document is canceled, for instance, by the document handling module 130. In this regard, at block 322, the document may have been determined as merely comprising a duplicate copy of an existing document in the archive, and therefore, the document need not be archived.

However, in response to a determination that the discovery relevant attributes that do not change the last modified time identified at block 304 have changed, at block 322, the discovery relevant attributes are tracked as time varying attributes of the existing documents version, for instance, by the document handling module 130. In one regard, tracking the discovery relevant attributes is a metadata space saving optimization. In other words, just like tracking versions reduces the duplication of metadata, similarly for small changes like “Read/Unread” or category changes, even creating a version is an overhead. As such, these relatively small discovery relevant attributes are tracked, for instance, with an EffectiveFrom and EffectiveTo. That mechanism allows very efficient storage of properties varying over time. By way of example, in which a message is categorized as C1 at T1 and then changes to C2 at T2, we just have two entries associated with the same document version which track category as a time varying attribute with value C1 from T1->T2 and C2 from T2->Present. In this regard, the overhead associated with creating new versions for such small changes is avoided.

With reference back to block 312, in response to a determination that the first source identifier of the document does not exist in the archive, for instance, within the set of documents in the archive matching the source set identifier, at block 324 (following “A” to FIG. 3B), a determination is made as to whether the second source identifier (SrcID2) of the document matches an archived second source identifier within the set of documents in the archive matching the source set identifier, for instance, by the second source identifier analyzing module 122. According to an example, a hash of the second source identifier is used to search the archive and/or indication of the documents contained in the archive for the match. As discussed above, various types of documents may not include a third element, and therefore the second source identifier of the document may have been set to a null value. In these instances, the operations identified in FIG. 3B may be skipped or omitted.

In response to a determination that the second source identifier of the document does not exist within the set of documents in the archive matching the source set identifier, the document is inserted into the archive, for instance, into the document set matching the source set identifier as a new version, as indicated at block 326.

However, in response to a determination that the second source identifier of the document does match an archived second source identifier within the set of documents in the archive matching the source set identifier, at block 314 (following “B” back to FIG. 3A), a determination is made as to whether the last modification time and the access control list of the document identified at block 304 exist within the set of documents in the archive matching the source set identifier, for instance by the LMT and ACL analyzing module 124. In addition, blocks 316-322 may be implemented as discussed above.

With reference now to FIG. 4, there is shown a table 400 depicting various source set identifiers, first source identifiers, and second source identifiers corresponding to various types of documents, according to an example. It should be clearly understood that the information contained in the table 400 is for illustrative purposes and thus, examples of the present disclosure should not be construed as being limited to the information contained in the table 400. In addition, the types of documents and the elements corresponding to the respective source set identifiers, first source identifiers, and the second source identifiers should not be construed as exhaustive of all the possible document types and elements that may be implemented in the examples of the present disclosure.

In one regard, the different types of documents have different elements because, for instance, the source systems in which these documents are respectively created, stored, and/or archived generally differ from each other. For example, there are a number of ways that e-mails may be archived, depending on the type of source system that implements the archiving of the e-mails. For instance, the e-mails may be captured through use of any of via logs, personal storage table (PST) files, Messaging APIs (MAPI's), exchange Web services (EWS), etc.

As discussed above, through implementation of either of the methods 200 and 300, a single method may be implemented to archive and perform versioning on various types of documents, regardless of their capture methods. In one regard, because a common archiving and versioning scheme may be implemented across multiple types of documents, the multiple types of documents may be stored uniformly. By way of example, the uniform storage of various types of documents may be useful in discovery processes, such as e-discovery processes, which is often implemented in litigation matters.

Some or all of the operations set forth in the methods 200 and 300 may be contained as a utility, program, or subprogram, in any desired computer accessible medium. In addition, the methods 200 and 300 may be embodied by computer programs, which may exist in a variety of forms both active and inactive. For example, they may exist as machine readable instructions, including source code, object code, executable code or other formats. Any of the above may be embodied on a non-transitory computer readable storage medium. Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

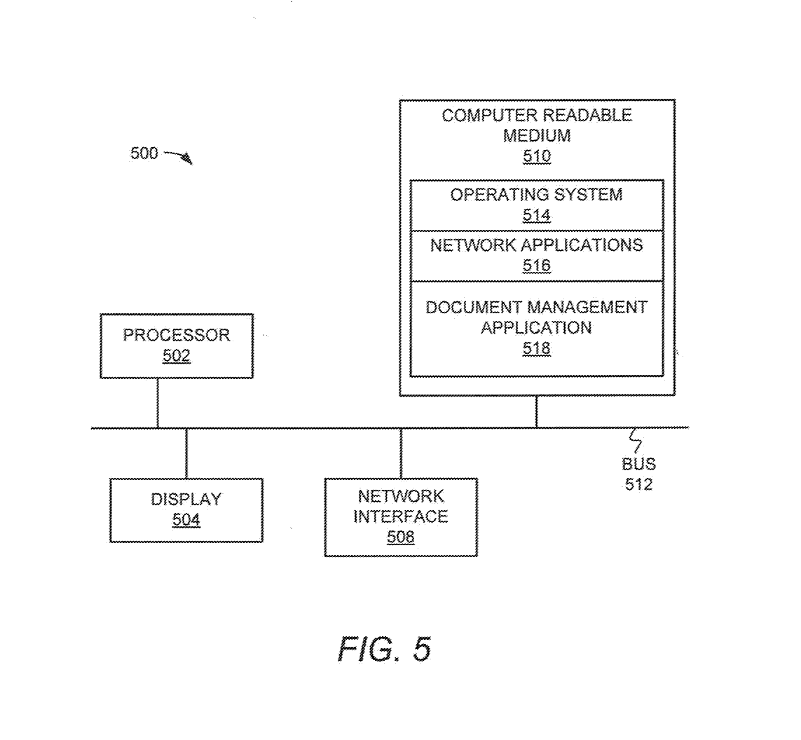

Turning now to FIG. 5, there is shown a schematic representation of a computing device 500, which may be employed to perform various functions of the electronic apparatus 102 depicted in FIG. 1, according to an example. The computing device 500 includes a processor 502, such as but not limited to a central processing unit; a display device 504, such as but not limited to a monitor; a network interface 508, such as but not limited to a Local Area Network LAN, a wireless 802.11x LAN, a 3G mobile WAN or a WiMax WAN; and a computer-readable medium 510. Each of these components is operatively coupled to a bus 512. For example, the bus 512 may be an EISA, a PCI, a USB, a FireWire, a NuBus, or a PDS.

The computer readable medium 510 comprises any suitable medium that participates in providing instructions to the processor 502 for execution. For example, the computer readable medium 510 may be non-volatile media, such as memory. The computer-readable medium 510 may also store an operating system 514, such as but not limited to Mac OS, MS Windows, Unix, or Linux; network applications 516; and a document management application 518. The operating system 514 may be multi-user, multiprocessing, multitasking, multithreading, real-time and the like. The operating system 514 may also perform basic tasks such as but not limited to recognizing input from input devices, such as but not limited to a keyboard or a keypad; sending output to the display 504; keeping track of files and directories on medium 510; controlling peripheral devices, such as but not limited to disk drives, printers, image capture device; and managing traffic on the bus 512. The network applications 516 include various components for establishing and maintaining network connections, such as but not limited to machine readable instructions for implementing communication protocols including TCP/IP, HTTP, Ethernet, USB, and FireWire.

The document management application 518 provides various components for managing versioning of an archived document as discussed above with respect to the methods 200 and 300 in FIGS. 2-3B. The document management application 518 may thus comprise the input/output module 112, the document information identifying module 114, the element mapping module 116, the source set identifier (ID) analyzing module 118, the first source ID analyzing module 120, the second source ID analyzing module 122, the last modification time (LMT) and access control list (ACL) analyzing module 124, the discovery relevant attributes analyzing module 126, the document status determining module 128, and the document handling module 130. In this regard, the document management application 518 may include modules for performing the methods 200 and/or 300.

In certain examples, some or all of the processes performed by the application 518 may be integrated into the operating system 514. In certain examples, the processes may be at least partially implemented in digital electronic circuitry, or in computer hardware, machine readable instructions (including firmware and software), or in any combination thereof, as also discussed above.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for managing versioning of an archived document having at least one of a first element, a second element, and a third element, said method comprising:
a) mapping at least one of the first element to a source set identifier, the second element to a first source identifier, and the third element to a second source identifier, wherein the source set identifier, the first source identifier, and the second source identifier are agnostic to a type of the document and a method in which the document is captured; and
b) determining, by a processor, whether the document comprises a copy of an existing document in an archive, a new version of an existing document in the archive, or a new document to be stored in the archive based upon an analysis of the mapped at least one of the source set identifier, the first source identifier, and the second source identifier.

2. The method according to claim 1, further comprising:
identifying a last modification time and an access control list of the document; and
wherein b) further comprises determining whether the document comprises a copy of an existing document in the archive, a new version of an existing document in the archive, or a new document to be stored in the archive further based upon an analysis of the last modification time and the access control list of the document.

3. The method according to claim 1, wherein b) further comprises:
determining whether the source set identifier exists in the archive in response to the first element being mapped to a source set identifier;
creating a new document set in the archive using the source set identifier in response to a determination that the source set identifier does not exist in the archive; and
inserting the document into the new document set.

4. The method according to claim 3, further comprising:
in response to a determination that the source set identifier does exist in the archive or in response to the source set identifier having a null value, determining whether the first source identifier matches an archived first source identifier within a set of documents in the archive matching the source set identifier.

5. The method according to claim 4, further comprising:
in response to a determination that the first source identifier matches an archived first source identifier within the set of documents in the archive matching the source set identifier, determining whether a last modification time and an access control list of the document exists within the set of documents in the archive matching the source set identifier; and
in response to a determination that the last modification time and an access control list of the document do not exist within the set of documents in the archive matching the source set identifier, inserting the document into the set of documents in the archive matching the source set identifier as a new version of an existing document.

6. The method according to claim 5, further comprising:
in response to a determination that the last modification time and the access control list of the document exist within the set of documents in the archive matching the source set identifier, determining whether discovery relevant attributes that don't change the last modification time have changed;
in response to a determination that the discovery relevant attributes that don't change the last modification time have changed, tracking the discovery relevant attributes as time varying attributes of an existing document version in the set of documents in the archive matching the source set identifier; and
in response to a determination that the discovery relevant attributes that don't change the last modification have not changed, canceling archiving of the document.

7. The method according to claim 4, further comprising:
in response to a determination that the first source identifier does not match an archived first source identifier within the set of documents in the archive matching the source set identifier, determining whether a second source identifier matches an archived second source identifier within the set of documents in the archive matching the source set identifier; and
in response to a determination that the second source identifier does not match an archived second source identifier within the set of documents in the archive matching the source set identifier, inserting the document into the set of documents in the archive matching the source set identifier as a new version of an existing document.

8. The method according to claim 7, further comprising:
in response to a determination that the second source identifier matches an archived second source identifier within the set of documents in the archive matching the source set identifier, determining whether a last modification time and an access control list of the document exists within the set of documents in the archive matching the source set identifier; and
in response to a determination that the last modification time and an access control list of the document do not exist within the set of documents in the archive matching the source set identifier, inserting the document into the set of documents in the archive matching the source set identifier as a new version of an existing document.

9. The method according to claim 8, further comprising:
in response to a determination that the last modification time and the access control list of the document exist within the set of documents in the archive matching the source set identifier, determining whether discovery relevant attributes that don't change the last modification time have changed;
in response to a determination that the discovery relevant attributes that don't change the last modification time have changed, tracking the discovery relevant attributes as time varying attributes of an existing document version in the set of documents in the archive matching the source set identifier; and
in response to a determination that the discovery relevant attributes that don't change the last modification have not changed, canceling archiving of the document.

10. The method according to claim 1, wherein the document comprises an e-mail.

11. An apparatus for managing versioning of of an archived document having at least one of a first element, a second element, and a third element, said apparatus comprising:
at least one module to,
map at least one of the first element to a source set identifier, the second element to a first source identifier, and the third element to a second source identifier, wherein the source set identifier, the first source identifier, and the second source identifier are agnostic to a type of the document and a method in which the document is captured;
identify a last modification time and an access control list of the document; and
determine whether the document comprises a copy of an existing document in an archive, a new version of an existing document in the archive, or a new document to be stored in the archive based upon an analysis of the last modification time and the access control list of the document and the mapped at least one of the source set identifier, the first source identifier, and the second source identifier; and
a processor to implement the at least one module.

12. The apparatus according to claim 11, wherein the at least one module is further to:
determine whether the source set identifier exists in the archive in response to the first element being mapped to a source set identifier;
create a new document set in the archive identified by the source set identifier in response to a determination that the source set identifier does not exist in the archive; and
insert the document into the new document set.

13. The apparatus according to claim 11, wherein the at least one module is further to:
store the document in a document set identified by the source set identifier as a new document or a new version of an existing document based upon the determination.

14. A non-transitory computer readable storage medium on which is stored machine readable instructions that when executed by a processor, implement a method for managing versioning of an archived document having at least one of a first element, a second element, and a third element, said machine readable instructions comprising code to:
map at least one of the first element to a source set identifier, the second element to a first source identifier, and the third element to a second source identifier, wherein the source set identifier, the first source identifier, and the second source identifier are agnostic to a type of the document and a method in which the document is captured;
identify a last modification time and an access control list of the document; and
determine whether the document comprises a copy of an existing document in an archive, a new version of an existing document in the archive, or a new document to be stored in the archive based upon an analysis of the last modification time and the access control list of the document and the mapped at least one of the source set identifier, the first source identifier, and the second source identifier.

15. The non-transitory computer readable storage medium according to claim 14, wherein the machine readable instructions further comprise code to:
store the document in a document set identified by the source set identifier as a new document or a new version of an existing document based upon the determination.
